(19) United States
(12) Patent Application Publication
(10) Pub. No.: US 2011/0052136 A1
(43) Pub. Date: Mar. 3, 2011

(54) PATTERN-BASED MONITORING OF MEDIA SYNCHRONIZATION

(75) Inventors: Blake Homan, Saratoga, CA (US); Bill Reckwerdt, Saratoga, CA (US)

(73) Assignee: Video Clarity, Inc., Campbell, CA (US)

(21) Appl. No.: 12/552,026

(22) Filed: Sep. 1, 2009

(51) Int. Cl. H04N 5/91; G06F 15/16; H04N 5/932; H04N 9/80

(52) U.S. Cl. 386/201; 709/231; 386/E05.001; 386/241

(57) ABSTRACT

Reference media data and monitored media data are accessed. Media data may be accessed as streams of media data, as media data stored in a memory, or any combination thereof. A first pattern of first media content (e.g., a video event) and a second pattern of second media content (e.g., an audio event) are identified in the reference media data, and their corresponding counterparts are identified in the monitored media data as a third pattern of first media content (e.g., a video event) and a fourth pattern of second media content (e.g., an audio event). After these patterns are identified, a first time interval is determined between two of the patterns, and a second time interval is determined between two of the patterns. A difference between the two time intervals is then determined and stored in a memory. This difference may be presented as a media synchronization error.

### TECHNICAL FIELD

The subject matter disclosed herein generally relates to monitoring of media. Specifically, the present disclosure addresses methods, devices, and systems involving pattern-based monitoring of the media synchronization.

### BACKGROUND

In the 21st century, media frequently takes the form of media data that may be communicated as a stream of media data, stored permanently or temporarily in a storage medium, or any combination thereof. In many situations, multiple streams of media data, with each stream representing distinct media content, are combined for synchronized rendering (e.g., playback). For example, a movie generally includes a video track and at least one audio track. The movie may also include non-video non-audio content, such as, for example, textual content used in providing closed captioning services or an electronic programming guide. As a further example, a broadcast television program may include interactive content for providing enhanced media services (e.g., reviews, ratings, advertisements, internet-based content, games, shopping, or payment handling).

Combinations of various media data are well-known in the art. Such combinations of media include audio accompanied by metadata that describes the audio, video with multiple camera angles (e.g., from security cameras or for flight simulator screens), video with regular audio and commentary audio, video with audio in multiple languages, and video with subtitles in multiple languages. In short, any number of streams of media data, of any type, may be combined together to effect a particular transmission of information or to provide a particular viewer experience. This combining of media data streams is often referred to as “multiplexing” the streams together.

Synchronization between or among multiplexed streams of media data may be affected by various systems and devices used to communicate the media data. It is generally considered helpful to preserve the synchronization of multiplexed streams of media data. For example, in a movie, the video and audio tracks of the movie are synchronized so that audio from spoken dialogue is heard with corresponding video of the speaker talking. This is commonly known as “lip-sync” between audio and video. Any shifting of the audio with respect to the video degrades lip-sync.

Although mild degradations in synchronization are common and generally acceptable to many viewers, if the synchronization becomes too degraded, the ability of the media to effect a particular transmission of information or to provide a particular viewer experience may be lost. In the movie example, if the audio is heard too far behind, or too far in advance of, the corresponding video, lip-sync is effectively lost, and the viewer experience may be deemed unacceptable by an average viewer.

### BRIEF DESCRIPTION OF THE DRAWINGS

Some embodiments are illustrated by way of example and not limitation in the figures of the accompanying drawings in which:

FIG. 1 is a block diagram illustrating a system having a reference path and a monitored path between a media source and a monitoring device, according to some example embodiments;

FIG. 2 is a block diagram illustrating a system that enables communication of media data between an encoder and the monitoring device, according to some example embodiments;

FIG. 3 is a block diagram illustrating a monitoring device, according to some example embodiments;

FIGS. 4-5 are a diagrams illustrating relationships among video and audio events identified in reference and monitored streams of media data, according to some example embodiments;

FIG. 6 is a diagram illustrating relationships among multiple patterns of media content identified in reference and monitored media data, according to some example embodiments;

FIG. 7 is a block diagram illustrating video frames and audio samples within media data, according to some example embodiments;

FIG. 8 is a block diagram illustrating border pixels and image pixels within a video frame, according to some example embodiments;

FIG. 9 is a flow chart illustrating operations in a method of monitoring media synchronization, according to some example embodiments;

FIG. 10 is a flow chart illustrating operations in a method of monitoring media synchronization, according to some example embodiments;

FIG. 11 is a flow chart illustrating operations in a method of identifying a pattern of media content based on reference and monitored media data, according to some example embodiments;

FIG. 12 is a flow chart illustrating operations in a method of identifying a pattern of media content based on first and second portions of media data, according to some example embodiments; and

FIG. 13 is a block diagram illustrating components of a machine, according to some example embodiments, able to read instructions from a machine-readable medium and perform any one or more of the methodologies discussed herein.

### DETAILED DESCRIPTION

Example methods, devices, and systems are directed to pattern-based monitoring of media synchronization. Examples merely typify possible variations. Unless explicitly stated otherwise, components and functions are examples and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

To monitor media synchronization of media data, reference media data (e.g., original source media data) and monitored media data (e.g., transmitted and received media data) are accessed. Media data may be accessed as streams of media data, as media data stored in a memory, or any combination thereof. A first pattern of first media content (e.g., a video event) and a second pattern of second media content (e.g., an audio event) are identified in the reference media data, and their corresponding counterparts are identified in the monitored media data as a third pattern of first media content (e.g., a video event) and a fourth pattern of second media content (e.g., an audio event). After these four patterns are identified, a first time interval is determined between two of the patterns, and a second time interval is determined between two of the patterns. A difference between the two time intervals is then determined and stored in a memory. This difference may be presented via a user interface as a media synchronization error of the monitored media data as compared to the reference media data.

Identification of a pattern of media content may be based on any type of information used to record, store, communicate, render, or otherwise represent the media content. For example, a pattern of media content may be identified based on information that varies in time. Examples of such time-variant information include, but are not limited to, luminance information (e.g., luminance of video), amplitude information (e.g., amplitude of a sound wave), textual information (e.g., text in subtitles), time code information (e.g., a reference clock signal), automation information (e.g., instructions to control a machine), or any combination thereof.

In some example embodiments, identification of a pattern involves selecting a reference portion of the reference media data (e.g., a reference video or audio clip) and a candidate portion of the monitored media data (e.g., a candidate video or audio clip), determining a correlation value based on the reference and candidate portions, and determining that the correlation value is sufficient to identify the pattern (e.g., a video or audio event). In certain example embodiments, identification of a pattern involves selecting first and second portions of media data (e.g., first and second video frames of a video clip, or first and second audio envelopes of an audio clip), respectively determining first and second values of the first and second portions, determining a temporal change based on the first and second values, and determining that the temporal change is sufficient to identify the pattern (e.g., a video or audio event). In various example embodiments, identification of a video event involves removing a video image border (e.g., padding, matting, or letter-boxing) by selecting a video frame, identifying pixels representative of the image border, and storing the image pixels as the video frame.

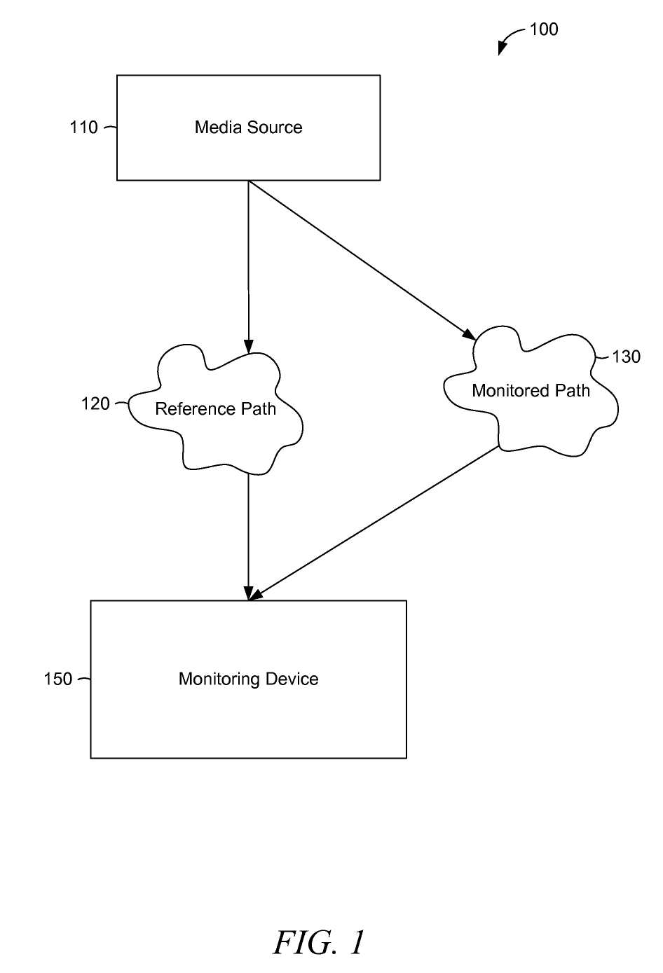

FIG. 1 is a block diagram illustrating a system 100 having a reference path 120 and a monitored path 130 between a media source 110 and a monitoring device 150, according to some example embodiments. The media source 110 communicates media data to the monitoring device 150. The communication occurs via the reference path 120 and via the monitored path 130. The monitoring device 150 monitors media synchronization of media data communicated via the monitored path 130 as compared to media synchronization of media data communicated via the reference path 120.

The same media content is communicated via both the reference path 120 and the monitored path 130, even though media data communicated via the reference path 120 may differ from media data communicated via the monitored path 130. For example, the monitored path 130 may involve use of one or more systems, devices, conversions, transformations, alterations, or modifications that are not used in the reference path 120. As a result, considering data as binary bits of information, the media data communicated via the reference path 120 will differ significantly from the media data communicated via the monitored path 130. However, for example, if the media data communicated via the reference path 120 represents particular media content (e.g., a fiery explosion in a movie), then the media data communicated via the monitored path 130 represents that same particular media content (e.g., the same fiery explosion in the same movie).

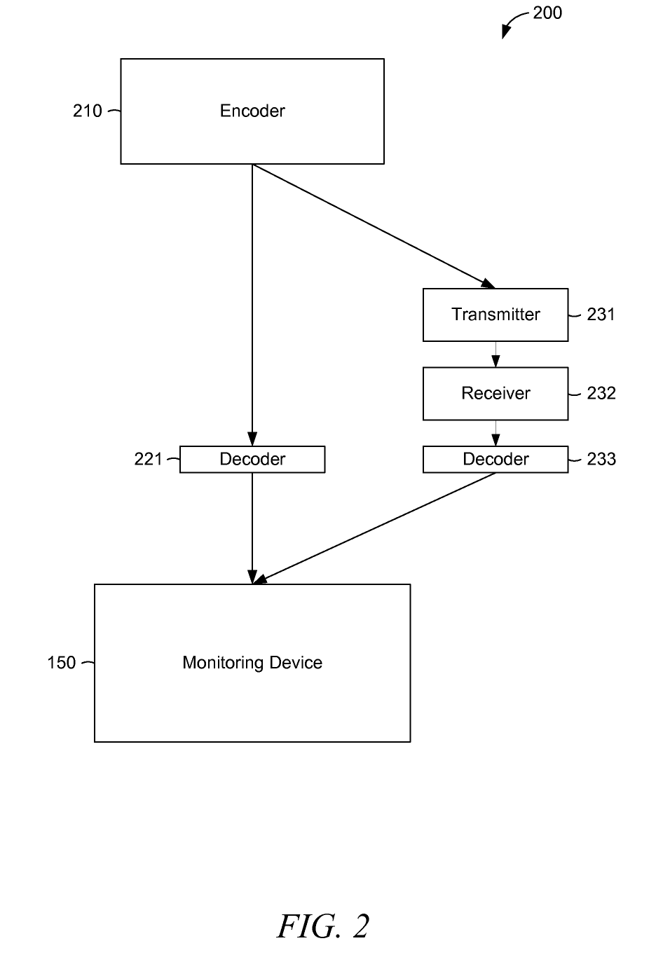

FIG. 2 is a block diagram illustrating a system 200 that enables communication of media data between an encoder 210 and the monitoring device 150, according to some example embodiments. The encoder 210 is a media source (e.g., media source 110). The encoder 210 communicates media data to the monitoring device 150. The communication is configured to occur through a reference decoder 221, as well as through a combination of devices including a transmitter 231, a receiver 232, and a monitored decoder 233. The communication path through the reference decoder 221 constitutes a reference path (e.g., a reference path 120). The communication path through the combination of devices constitutes a monitored path (e.g., monitored path 130). This configuration enables the monitoring device 150 to monitor media synchronization of the media data communicated to the monitoring device 150 through the transmitter 231 and the receiver 232, as compared to media synchronization of the media data communicated to the monitoring device 150 without the transmitter 231 and the receiver 232. This has an effect of monitoring media synchronization errors introduced by the transmitter 231, the receiver 232, or any combination thereof.

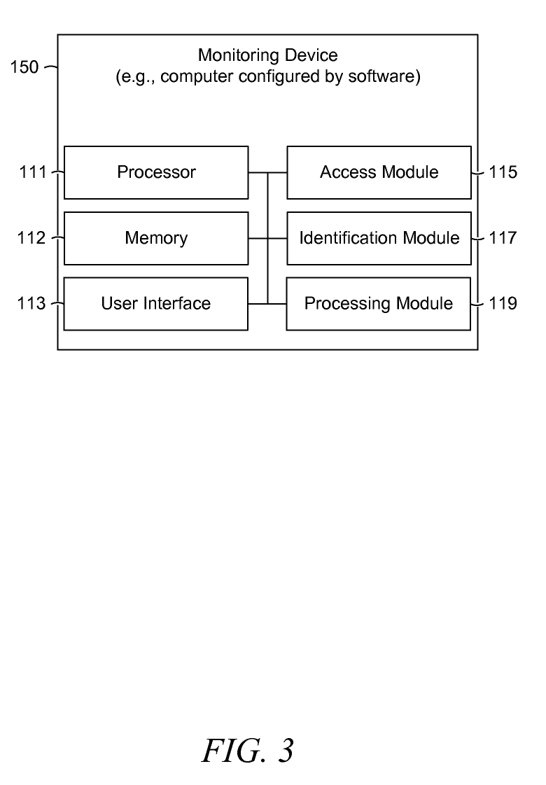

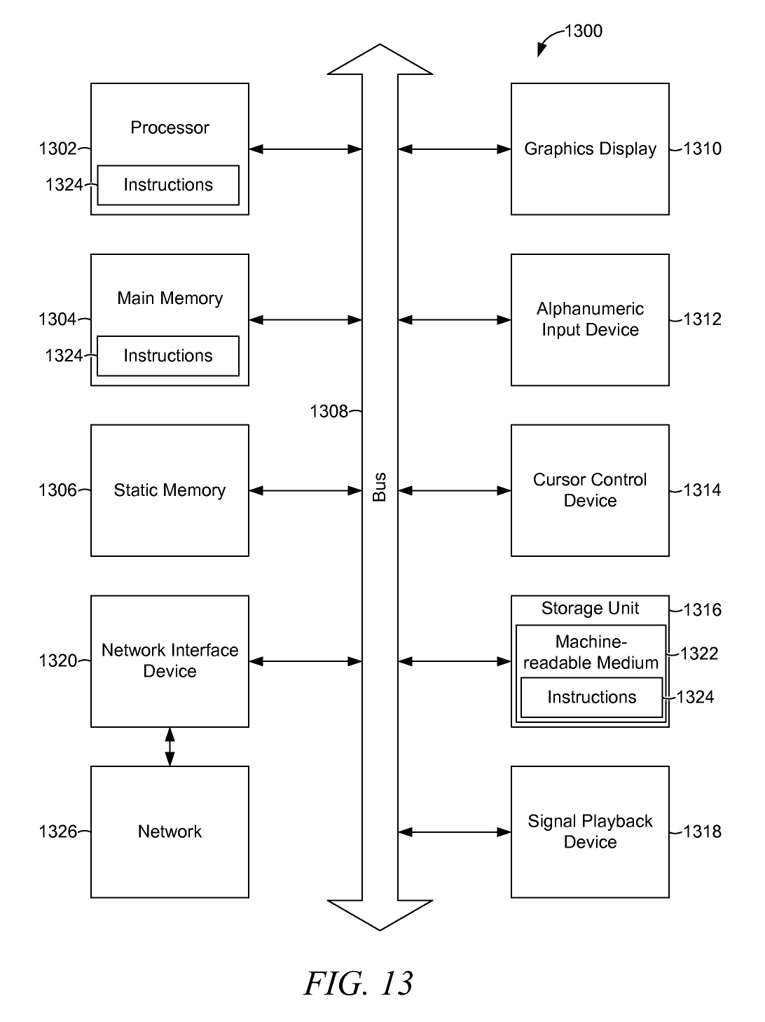

FIG. 3 is a block diagram illustrating the monitoring device 150, according to some example embodiments. The monitoring device 150 may be implemented as a computer system configured by a set of instructions (e.g., software) to perform any one or more of the methodologies described herein. A computer system able to implement the monitoring device 150 is described in greater detail below with respect to FIG. 13. As shown, the monitoring device 150 includes a processor 111, a memory 112, a user interface 113, an access module 115, an identification module 117, and a processing module 119, all communicatively coupled to each other. According to some example embodiments, the access module 115, the identification module 117, and the processing module 119 are configured by instructions to operate as described herein.

The access module 115 accesses reference media data and monitored media data. To this end, the access module 115 accesses a memory that stores media data permanently or temporarily (e.g., memory 112, a buffer memory, a cache memory, or a machine-readable medium). A stream of media data may be accessed by reading data payloads of network packets used to communicate the media data. In some example embodiments, accessing a stream of media data involves reading the data payloads from a memory. The access module 115 may be implemented as a hardware module, a processor implemented module, or any combination thereof.

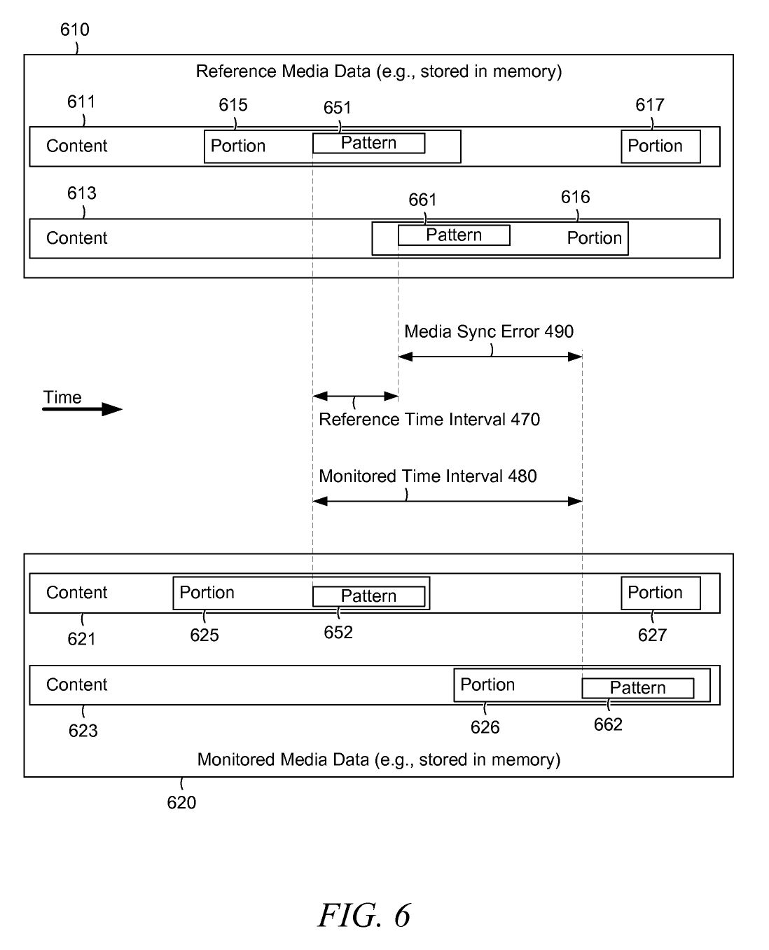

The identification module 117 identifies a pattern of media content. For example, the identification module 117 may identify a video event in reference media data, a video event in monitored media data, an audio event in reference media data, an audio event and monitored media data, or any combination thereof. As additional examples, the identification module 117 may identify a text event in reference media data, a text event in monitored media data, a time code event in reference media data, a time code event in monitored media data, or any combination thereof. Further operation of the identification module 117 may identify further patterns of media content. Example methods of identifying a pattern of media content are described in greater detail below with respect to FIGS. 7-12. The identification module 117 may implement any one or more of these example methods.

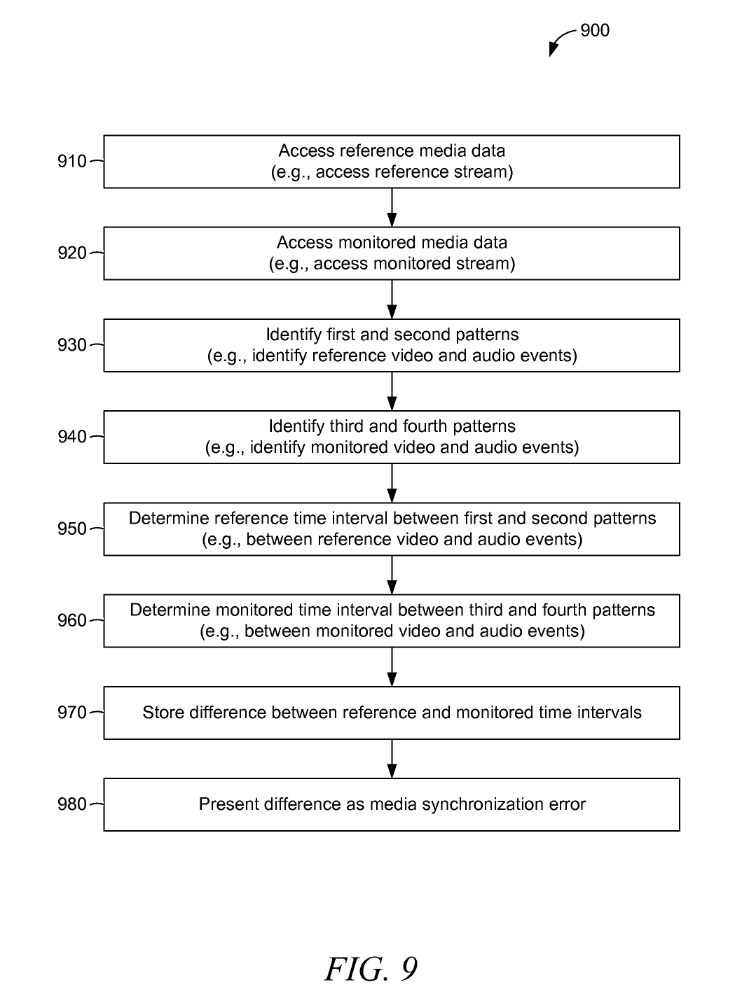

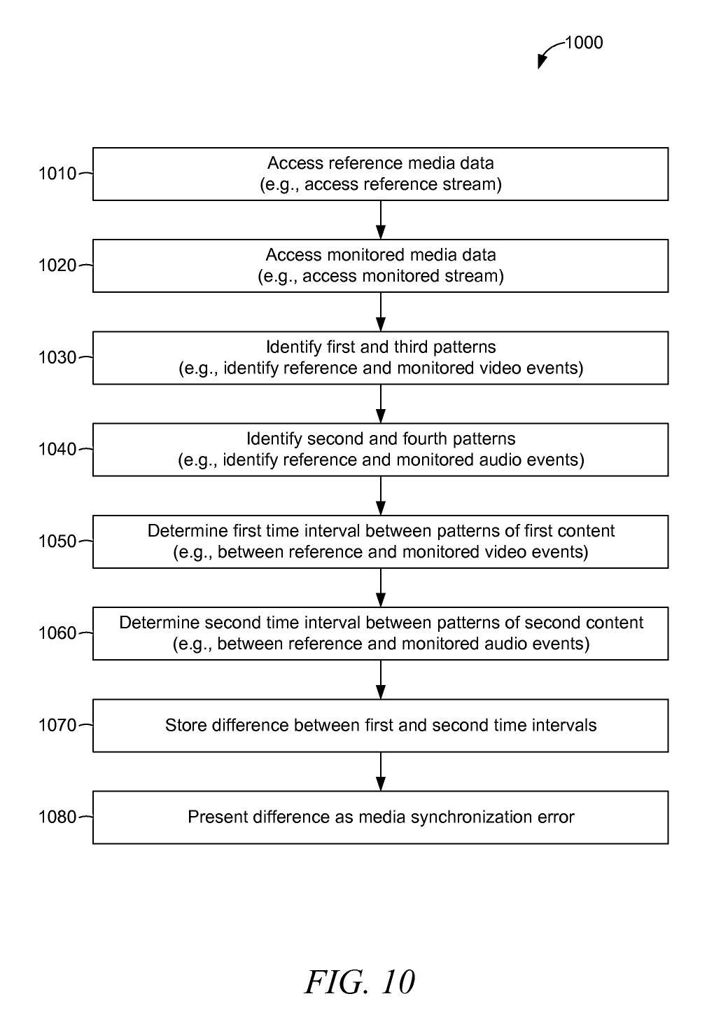

The processing module 119 determines a first time interval between two patterns identified by the identification module 117. The processing module 119 also determines a second time interval between two patterns identified by the identification module 117. The two patterns used to determine the first time interval need not be the same two patterns used to determine the second time interval. The processing module 119 determines a difference between the first and second time intervals and stores the difference in the memory 112. Example methods of determining first and second time intervals are described in greater detail below with respect to FIGS. 9-10. The processing module 119 may implement any one or more of these example methods.

The processor 111 may be any type of processor as described in greater detail below with respect to FIG. 13. The memory 112 may be any type of memory as described in greater detail below with respect to FIG. 13. The user interface 113 may be any type of user interface or user interface module able to communicate information between the monitoring device 150 and a user of the monitoring device 150. A user may be a human user or a machine user (e.g., a computer or a cellphone). For example, the user interface 113 may be a network interface device or graphics display, as described in greater detail below with respect to FIG. 13.

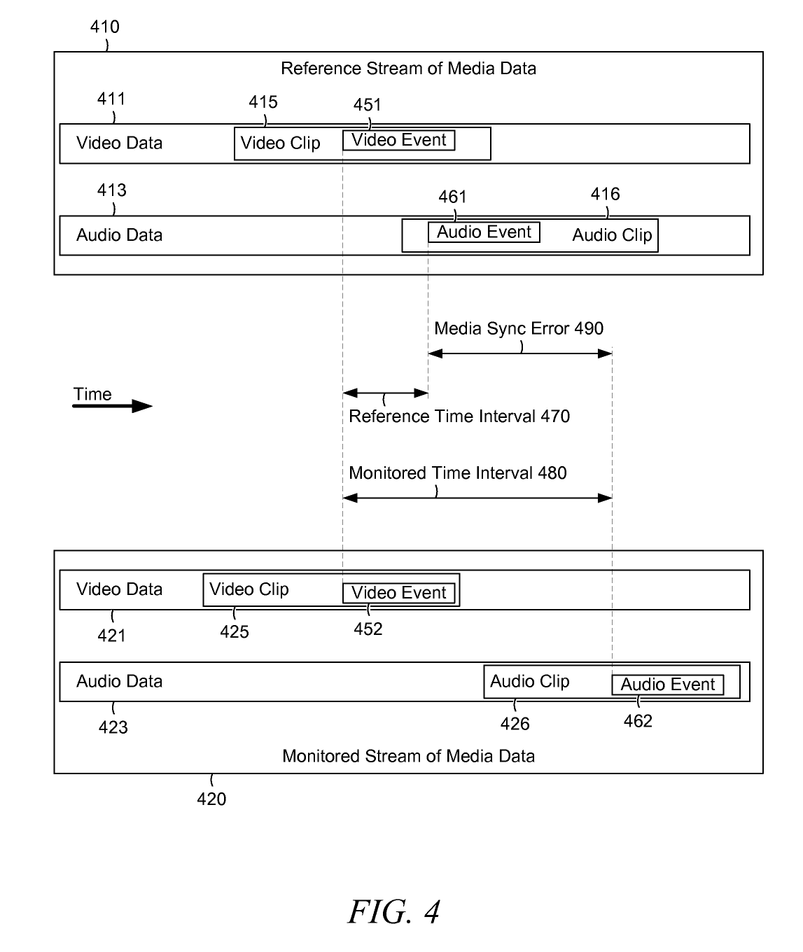

FIGS. 4-5 are diagrams illustrating relationships among video and audio events identified in reference and monitored streams of media data, according to some example embodiments. A reference stream 410 of media data is shown in temporal comparison to a monitored stream 420 of media data. The reference stream 410 includes reference video data 411 and reference audio data 413, while the monitored stream 420 includes monitored video data 421 and a monitored audio data 423.

The reference video data 411 includes a reference video clip 415, which in turn includes a reference video event 451. The reference audio data 413 includes a reference audio clip 416, which in turn includes a reference audio event 461. Similarly, the monitored video data 421 includes a monitored video clip 425, which in turn includes a monitored video event 452, and the monitored audio data 423 includes a monitored audio clip 426, which in turn includes a monitored audio event 462.

The reference video event 451 and the monitored video event 452 correspond to each other and represent the same video content (e.g., a fiery explosion in a movie). Similarly, reference audio event 461 and the monitored audio event 462 correspond to each other and represent the same audio content (e.g., a loud boom). The audio content corresponds to the video content in the sense that both have been multiplexed into the reference stream 410 for synchronized rendering. However, nothing requires that the audio content correspond contextually, semantically, artistically, or musically with the video content. For example, the audio content may be dialogue that corresponds to video content other than the video content represented in the reference video event 451 and the monitored video event 452.

As shown in FIG. 4, the reference stream 410 and the monitored stream 420 have been temporally aligned with respect to each other so that the reference video event 451 and the monitored video event 452 begin at the same time, as shown by a broken line connecting video events 451 and 452.

As shown in FIG. 4, the reference audio event 461 begins a relatively short time after its corresponding video event in the reference stream 410, namely, reference video event 451, as shown by a reference time interval 470. The reference time interval 470 represents the amount of delay between the reference video event 451 and the reference audio event 461. This may be referred to as a reference lip-sync delay.

As shown in FIG. 4, the monitored audio event 462 begins a relatively long time after its corresponding video event in the monitored stream 420, namely, monitored video event 452, as shown by a monitored time interval 480. The monitored time interval 480 represents the amount of delay between the monitored video event 452 and the monitored audio event 462. This may be referred to as a monitored lip-sync delay.

As shown in FIG. 4, the difference between the reference time interval 470 and the monitored time interval 480 is shown by a media sync error 490. The media sync error 490 represents an additional delay that has been introduced into the monitored stream 420 (e.g., introduced by various systems and devices used to communicate the monitored stream 420). This may be referred to as a media synchronization error, or more specifically, as a lip-sync error in the monitored stream 420 with respect to the reference stream 410.

In FIG. 5, the reference stream 410 and the monitored stream 420 are not temporally aligned with respect to each other, in the sense that the reference video event 451 does not begin at the same time as the monitored video event 452. Instead, the monitored video event 452 begins a short time after the beginning of the reference video event 451. This delay between video events 451 and 452 is represented by a video time interval 570. The monitored audio event 462 begins a much longer time after the beginning of the reference audio event 461. This delay between audio events 461 in 462 is represented by an audio time interval 580.

Because the reference video event 451 and the monitored video event 452 correspond to each other, and because the reference audio event 461 and the monitored audio event 462 correspond to each other, any difference between the video time interval 570 and the audio time interval 580 represents an additional delay that has been introduced into the monitored stream 420. As noted above, this may be referred to as a media synchronization error (e.g., a lip-sync error) in the monitored stream 420 with respect to the reference stream 410.

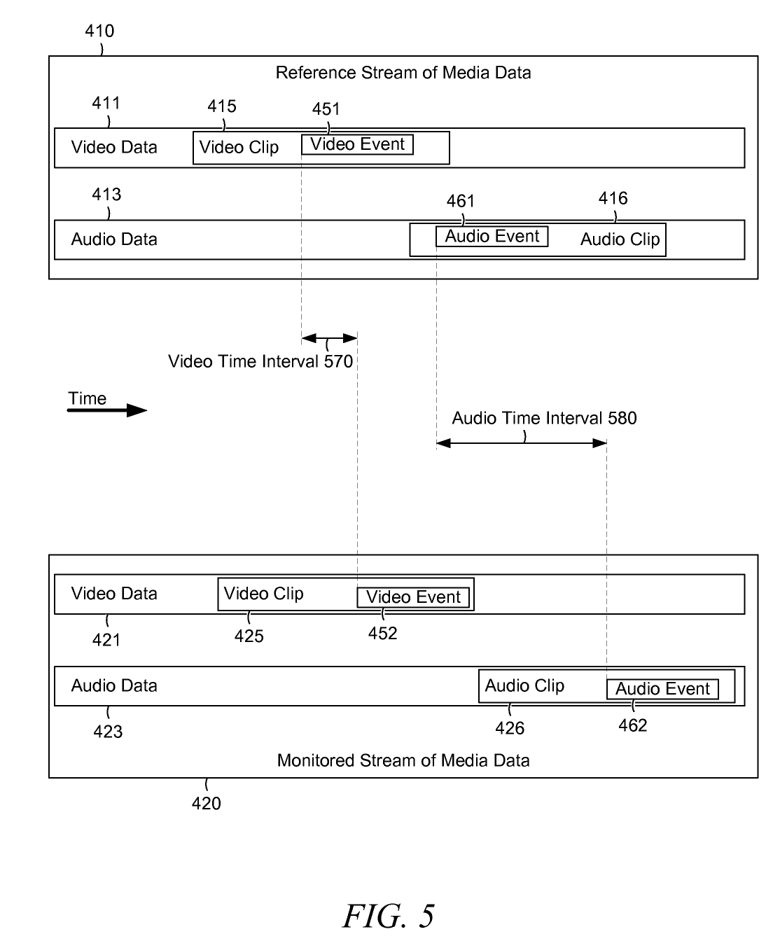

FIG. 6 is a diagram illustrating relationships among multiple patterns of media content identified in reference and monitored media data, according to some example embodiments. Reference media data 610 is shown in temporal comparison to monitored media data 620, either or both of which may be stored in a memory (e.g., memory 112). The reference media data 610 includes media content 611 and media content 613, while the monitored media data 620 includes media content 621 and media content 623. Media content 611 and media content 621 are of the same type of information, referred to as first media content (e.g., video content). Similarly, media content 613 and media content 623 are of the same type of information, referred to as second media content (e.g., audio content). Each of the first media content and the second media content may be of any type of information used to record, store, communicate, render, or otherwise represent media content, including but not limited to the examples discussed above.

In the reference media data 610, media content 611 includes a portion 615, which in turn includes a first pattern 651. Media content 611 also includes another portion 617. Media content 613 includes a portion 616, which in turn includes a second pattern 661. Similarly, in the monitored media data 620, media content 621 includes a portion 625, which in turn includes a third pattern 652. Media content 621 also includes an additional portion 627. Media content 623 includes a portion 626, which in turn includes a fourth pattern 662.

As shown in FIG. 6, the reference time interval 470 represents the amount of delay between the first pattern 651 and the second pattern 661. This may be referred to as a reference delay. The monitored time interval 480 represents the amount of delay between the third pattern 652 and the fourth pattern 662, which may be referred to as a monitored delay. The media sync error 490 is the difference between the reference time interval 470 and the monitored time interval 480. The media sync error 490 represents an additional delay that has been introduced into the monitored media data 620, which may be referred to as a media synchronization error in the monitored media data 620 with respect to the reference media data 610.

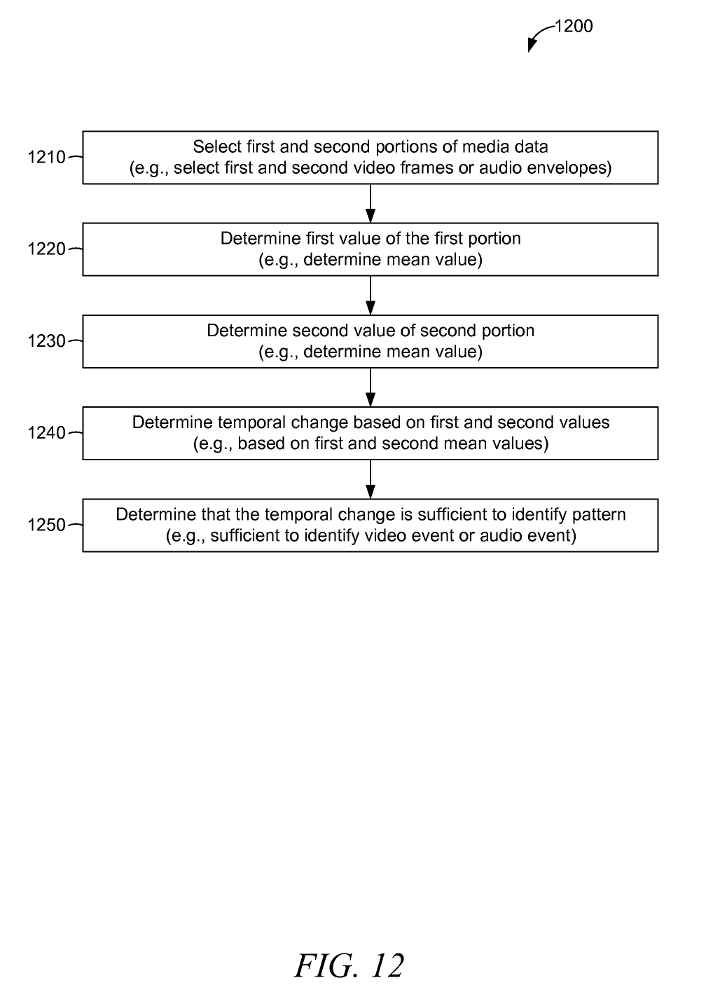

FIG. 7 is a block diagram illustrating video frames 750 and audio samples 760 within media data 710, according to some example embodiments. The media data 710 includes video data 411 and audio data 413. The video data 411 includes a video clip 415, which in turn includes the video frames 750. The audio data 413 includes an audio clip 416, which in turn includes the audio samples 760. The audio samples 760 may be considered as subdivided into one or more audio envelopes, which may in some cases overlap with each other within the audio samples 760. As explained in greater detail below with respect to FIG. 12, identification of a pattern of media content may be based on the video frames 750 or the audio samples 760.

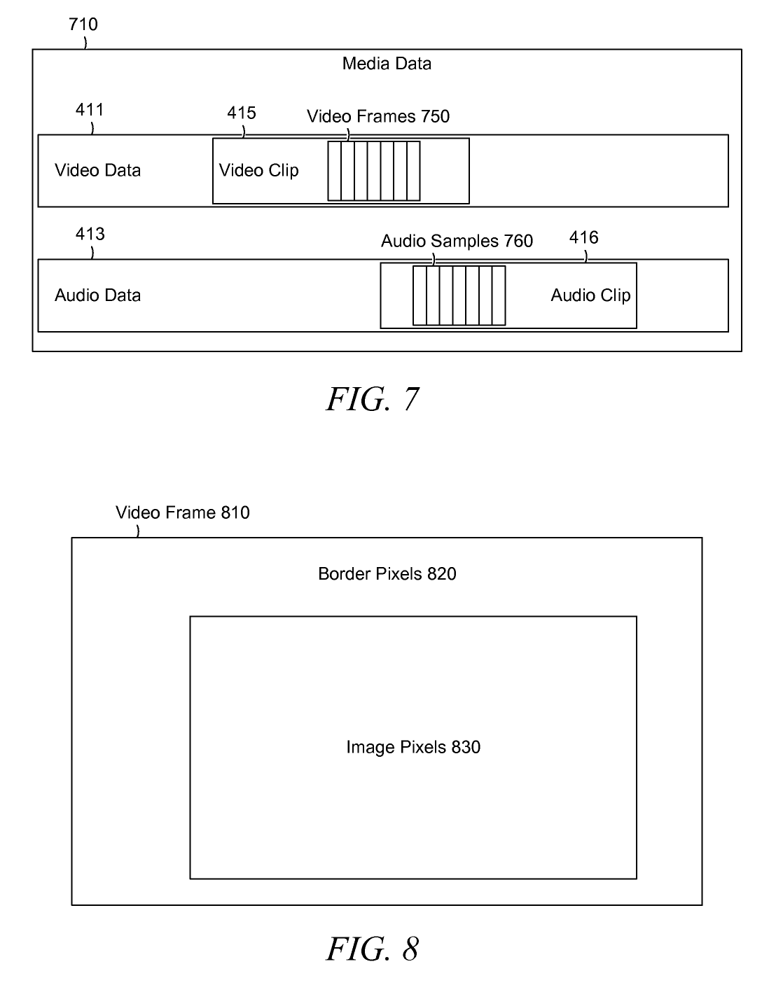

FIG. 8 is a block diagram illustrating border pixels 820 and image pixels 830 within a video frame 810, according to some example embodiments. The video frame 810 may be one of the video frames 750. The video frame 810 includes the border pixels 820 and image pixels 830. The image pixels 830 represent image content of the video frame 810, while the border pixels 820 represent non-image information (e.g., padding, matting, or letter boxing). As shown, the border pixels 820 surround the image pixels 830 on all sides. This need not be the case, however, and the border pixels 820 may be located along any one or more edges of the video frame 810, contiguously or non-contiguously, in any quantity along each edge.

In any of the methodologies discussed herein (e.g., with respect to FIG. 12 below), a video frame (e.g., video frame 810) may be processed to remove some or all of any border pixels (e.g., border pixels 820) contained therein. In some example embodiments, the processing involves selecting the video frame, identifying the border pixels, and storing the remaining pixels as the video frame, the remaining pixels being considered as image pixels (e.g., image pixels 830) of the video frame. This processing may be applied to multiple video frames of one or more video clips (e.g., video clips 415 and 425). With border pixels removed, further processing of the one or more video clips is based on their respective image pixels. This has an effect of facilitating an identification of a video event (e.g., video event 452) as corresponding to another video event (e.g., video event 451).

FIG. 9 is a flow chart illustrating operations in a method 900 of monitoring media synchronization, according to some example embodiments.

In operation 910, the access module 115 accesses reference media data (e.g., reference media data 610, or reference stream 410) stored in the memory 112. In operation 920, the access module 115 accesses monitored media data (e.g., monitored media data 620, or monitored stream 420) stored in the memory 112.

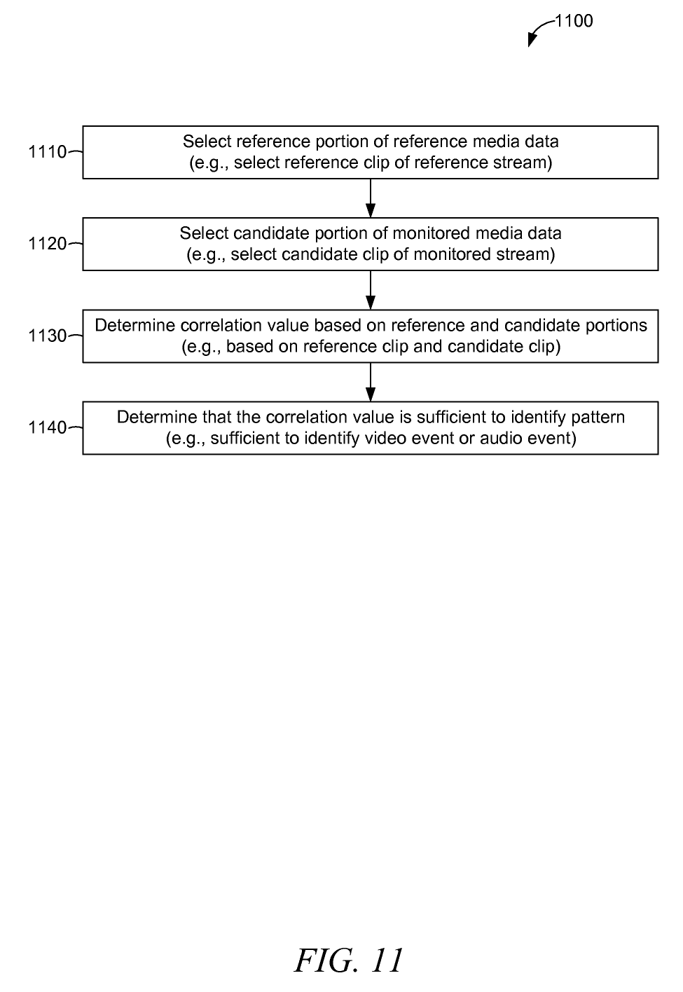

In operation 930, the identification module 117 identifies a first pattern of first media content (e.g., pattern 651, or video event 451) and identifies a second pattern of second media content (e.g., pattern 661, or audio event 461). The identifications of the first and second patterns are based on the reference media data accessed in operation 910. Further details with respect to identification of a pattern are given below are described below with respect to FIGS. 11 and 12.

In operation 940, the identification module 117 identifies a third pattern of first media content (e.g., pattern 652, or video event 452) and identifies a fourth pattern of second media content (e.g., pattern 662, or audio event 462). The identifications of the third and fourth patterns are based on the monitored media data accessed in operation 920.

In operation 950, the processing module 119 determines a reference time interval (e.g., reference time interval 470) between the first and second patterns, which were identified in operation 930. For example, the processing module 119 may determine the reference time interval by calculating a time difference (e.g., via a subtraction operation) between the starting times of the first and second patterns. In operation 960, the processing module 119 determines a monitored time interval (e.g., monitored time interval 480) between the third and fourth patterns, which were identified in operation 940. As an example, the processing module 119 may determine the monitored time interval by calculating a time difference between the starting times of the third and fourth patterns.

In operation 970, the processing module 119 determines and stores a difference between the reference time interval (e.g., reference time interval 470) and the monitored time interval (e.g., monitored time interval 480). For example, the processing module 119 may subtract the monitored time interval from the reference time interval to obtain the difference between the two time intervals. The difference is stored in the memory 112. In operation 980, the user interface module 113 presents the difference as a media synchronization error (e.g., media sync error 490).

FIG. 10 is a flow chart illustrating operations in a method 1000 of monitoring media synchronization, according to some example embodiments.

In operation 1010, the access module 115 accesses reference media data (e.g., reference media data 610, or reference stream 410) stored in the memory 112. In operation 1020, the access module 115 accesses monitored media data (e.g., monitored media data 620, or monitored stream 420) stored in the memory 112.

In operation 1030, the identification module 117 identifies a first pattern of first media content (e.g., pattern 651, or video event 451) and identifies a second pattern of second media content (e.g., pattern 661, or audio event 461). The identifications of the first and second patterns are based on the reference media data accessed in operation 1010. Further details with respect to identification of a pattern are given below are described below with respect to FIGS. 11 and 12.

In operation 1040, the identification module identifies a third pattern of first media content (e.g., pattern 652, or video event 452) and identifies a fourth pattern of second media content (e.g., pattern 662, or audio event 462). The identifications of the third and fourth patterns are based on the monitored media data accessed in operation 1020.

In operation 1050, the processing module 119 determines a first time interval (e.g., video time interval 570) between the first and third patterns, which are of first media content (e.g., video content). For example, the processing module 119 may determine the first time interval by calculating a time difference (e.g., via a subtraction operation) between the starting times of the first and third patterns. In operation 1060, the processing module determines a second time interval (e.g., audio time interval 580) between the second and fourth patterns, which are of second media content (e.g., audio content). As an example, the processing module may determine the second time interval by calculating a time difference between the starting times of the second and fourth patterns.

In operation 1070, the processing module 119 determines and stores a difference between the first time interval (e.g., video time interval 570) and the second time interval (e.g., audio time interval 580). For example, the processing module 119 may subtract the second time interval from the first time interval to obtain the difference between the two time intervals. The difference is stored in the memory 112. In operation 1080, the user interface module 113 presents the difference as a media synchronization error.

FIG. 11 is a flow chart illustrating operations in a method 1100 of identifying a pattern of media content based on reference and monitored media data, according to some example embodiments.

In operation 1110, the identification module 117 selects a reference portion of reference media data (e.g., portion 615 of reference media data 610, or video clip 415 of reference stream 410) stored in the memory 112. In operation 1120, the identification module 117 selects a candidate portion of monitored media data (e.g., portion 625 of monitored media data 620, or video clip 425 of monitored stream 420) stored in the memory 112.

In operation 1130, the identification module 117 determines a correlation value based on the reference and candidate portions, which were selected in operations 1110 and 1120. The correlation value is a result of a mathematical correlation function applied to reference data included in the reference portion and to candidate data included in the candidate portion.

Operation 1140 involves determining that the correlation value is sufficient to identify a pattern of media content (e.g., a video or audio event) as common to both the reference portion and the candidate portion. In operation 1140, the identification module 117 compares the correlation value to a correlation threshold. If the correlation value transgresses (e.g., exceeds) the correlation threshold, the identification module 117 determines that the correlation value is sufficient to treat the reference portion and the candidate portion as representative of the same pattern, thus facilitating identification of the pattern. For example, the identification module 117 may determine that the correlation value is sufficient to identify video event 452 of video clip 425 as corresponding to video event 451 of video clip 415. As another example, the identification module 117 may determine that the correlation value is sufficient to identify audio event 462 of audio clip 426 as corresponding to audio event 461 of audio clip 416.

FIG. 12 is a flow chart illustrating operations in a method 1200 of identifying a pattern of media content based on first and second portions of media data, according to some example embodiments.

In operation 1210, the identification module 117 selects first and second portions of media data (e.g., portions 615 and 617 from reference media data 610, or portions 625 and 627 from monitored media data 620) stored in the memory 112. The first and second portions are selected from the same media content (e.g., content 611). For example, the first and second portions may be two video frames (e.g., video frame 810) from a stream of video data (e.g., video data 411). As another example, the first and second portions may be two audio envelopes from a stream of audio data (e.g., audio data 413).

In operation 1220, the identification module 117 determines a first value of the first portion, which was selected in operation 1210. In operation 1230, the identification module 117 determines a second value of the second portion, which was selected in operation 1210. A first or second value may be a result of a mathematical transformation of data included in the selected portion of media content (e.g., a mean value, a median value, or a hash value). For example, a first or second value may be a mean value of a video frame (e.g., video frame 810, or image pixels 830 stored as a video frame). As another example, a first or second value may be a median value of an audio envelope.

In operation 1240, the identification module 117 determines a temporal change based on the first and second values, determined in operations 1220 and 1230. The temporal change represents a variation in time between the first portion of media content and the second portion of media content. For example, the temporal change may represent an increase in luminance from one video frame to another. As another example, the temporal change may represent a decrease in amplitude of sound waves from one audio envelope to another.

Operation 1250 involves determining that the temporal change is sufficient to identify a pattern of media content (e.g., a video or audio event). In operation 1250, the identification module 117 compares the temporal change to a temporal threshold. If the temporal change transgresses (e.g., exceeds) the temporal threshold, the identification module 117 determines that the temporal change is sufficient to treat the first and second portions as representative of an event within the media content (e.g., content 611), thus facilitating identification of the event. For example, the identification module 117 may determine that the temporal change is sufficient to identify a video event (e.g., video event 451) as being a video event. As another example, the identification module 117 may determine that the temporal change is sufficient to identify an audio event (e.g., audio event 461) as being an audio event.

Example embodiments may provide the capability to monitor media synchronization without any need to transmit a test pattern (e.g., an audio test tone, video color bars, or a beep-flash test signal) through the various systems and devices used to communicate the media data, since the appearance of test patterns may be regarded by viewers as interruptive of normal media programming. An ability to monitor media synchronization may facilitate detection of media synchronization errors induced by one or more systems, devices, conversions, transformations, alterations, or modifications involved in a monitored data path (e.g., monitored path 130). Example embodiments may also facilitate improvement in viewer experiences of media due to frequent or continuous monitoring of media synchronization, reduced network traffic corresponding to reduced complaints from viewers, and an improved capability to identify specific media data likely to cause a media synchronization error.

FIG. 13 illustrates components of a machine, according to some example embodiments, able to read instructions from a machine-readable medium and perform any one or more of the methodologies discussed herein. Specifically, FIG. 13 shows a diagrammatic representation of a machine in the example form of a computer system 1300 and within which instructions 1324 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment. The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1324 (sequential or otherwise) that specify actions to be taken by that machine. Further, while only a single machine is illustrated, the term “machine” shall also be taken to include a collection of machines that individually or jointly execute instructions 1324 to perform any one or more of the methodologies discussed herein.

The computer system 1300 includes a processor 1302 (e.g., a central processing unit (CPU), a graphics processing unit (GPU), a digital signal processor (DSP), a field-programmable gate array (FPGA), an application specific integrated circuit (ASIC), a radio-frequency integrated circuits (RFIC), or any combination thereof), a main memory 1304, and a static memory 1306, which communicate with each other via a bus 1308. The computer system 1300 may further include a graphics display unit 1310 (e.g., a plasma display panel (PDP), a liquid crystal display (LCD), a projector, a light emitting diode (LED), or a cathode ray tube (CRT)). The computer system 1300 may also include an alphanumeric input device 1312 (e.g., a keyboard), a cursor control device 1314 (e.g., a mouse, a trackball, a joystick, a motion sensor, or other pointing instrument), a storage unit 1316, a signal playback device 1318 (e.g., a speaker), and a network interface device 1320.

The storage unit 1316 includes a machine-readable medium 1322 on which is stored instructions 1324 (e.g., software) embodying any one or more of the methodologies or functions described herein. The instructions 1324 may also reside, completely or at least partially, within the main memory 1304, within the processor 1302 (e.g., within the processor's cache memory), or both, during execution thereof by the computer system 1300, the main memory 1304 and the processor 1302 also constituting machine-readable media. The instructions 1324 may be transmitted or received over a network 1326 via the network interface device 1320.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1322 is shown in an example embodiment to be a single medium, the term “machine-readable medium” should be taken to include a single medium or multiple media (e.g., a centralized or distributed database, or associated caches and servers) able to store instructions (e.g., instructions 1324). The term “machine-readable medium” shall also be taken to include any medium that is capable of storing instructions (e.g., software) for execution by the machine and that cause the machine to perform any one or more of the methodologies described herein. The term “machine-readable medium” shall accordingly be taken to include, but not be limited to, a data repository in the form of a solid-state memory, an optical medium, a magnetic medium, or any combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any combination thereof. For example, a hardware module may include dedicated circuitry or logic that is permanently configured to perform certain operations. For example, a hardware module may be a special-purpose processor, such as a field programmable gate array (FPGA) or an application-specific integrated circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing a reference stream of media data, the reference stream including a first video event and a first audio event;
accessing a monitored stream of media data, the monitored stream including a second video event and a second audio event, the second video event corresponding to the first video event, the second audio event corresponding to the first audio event;
identifying at least one of the first video event, the second video event, the first audio event, or the second audio event, the identifying being performed by a hardware module and by processing at least one of the reference stream or the monitored stream;
determining a first time interval between two events selected from a group consisting of the first video event, the second video event, the first audio event, and the second audio event;
determining a second time interval between two events selected from the group;
determining a difference between the first and second time intervals; and
storing the difference in a memory.

2. The method of claim 1 further comprising:
via a user interface, presenting the difference as a media synchronization error.

3. The method of claim 1, wherein the first time interval is a reference time interval between the first video event and the first audio event, and wherein the second time interval is a monitored time interval between the second video event and the second audio event.

4. The method of claim 1, wherein the first time interval is a video time interval between the first video event and the second video event, and wherein the second time interval is an audio time interval between the first audio event and the second audio event.

5. The method of claim 1, wherein the identifying of at least one of the first video event, the second video event, the first audio event, or the second audio event is based on information representative of at least one of a luminance of light or an amplitude of a sound wave.

6. The method of claim 1, wherein the identifying of at least one of the first video event, the second video event, the first audio event, or the second audio event includes:
selecting a reference video clip of the reference stream;
selecting a candidate video clip of the monitored stream;
determining a correlation value based on the reference video clip and on the candidate video clip; and
determining that the correlation value transgresses a correlation threshold to identify at least one of the first video event or the second video event.

7. The method of claim 1, wherein the identifying of at least one of the first video event, the second video event, the first audio event, or the second audio event includes:
selecting a video clip from one of the reference stream or the monitored stream, the video clip including a plurality of video frames;
selecting a first video frame of the video clip, the first video frame including a first plurality of pixels;
determining a first value of the first video frame based on the first plurality of pixels;
selecting a second video frame of the video clip, the second video frame including a second plurality of pixels;
determining a second value of the second video frame based on the second plurality of pixels;
determining a temporal change based on the first and second values; and
determining that the temporal change transgresses a temporal threshold to identify at least one of the first video event or the second video event.

8. The method of claim 1, wherein the identifying of at least one of the first video event, the second video event, the first audio event, or the second audio event includes:
selecting a video frame from one of the reference stream or the monitored stream, the video frame including a first plurality of pixels representative of an image and a second plurality of pixels representative of a border of the image;
identifying the second plurality of pixels; and
storing the first plurality of pixels as the video frame in the memory.

9. The method of claim 1, wherein the identifying of at least one of the first video event, the second video event, the first audio event, or the second audio event includes:
selecting a reference audio clip of the reference stream;
selecting a candidate audio clip of the monitored stream;
determining a correlation value based on the reference audio clip and on the candidate audio clip; and
determining that the correlation value transgresses a correlation threshold to identify at least one of the first audio event or the second audio event.

10. The method of claim 1, wherein the identifying of at least one of the first video event, the second video event, the first audio event, or the second audio event includes:
selecting an audio clip from one of the reference stream or the monitored stream;
determining a first audio envelope of the audio clip, the first audio envelope corresponding to a first plurality of samples;
determining a first value of the first audio envelope based on the first plurality of samples;
determining a second audio envelope of the audio clip, the second audio envelope corresponding to a second plurality of samples;
determining a second value of the second audio envelope based on the second plurality of samples;
determining a temporal change based on the first and second values; and
determining that the temporal change transgresses a temporal threshold to identify at least one of the first audio event or the second audio event.

11. A method comprising:
accessing reference media data stored in a memory, the reference media data including a first pattern of first media content and including a second pattern of second media content;
accessing monitored media data stored in the memory, the monitored media data including a third pattern of first media content and including a fourth pattern of second media content, the third pattern corresponding to the first pattern, the fourth pattern corresponding to the second pattern;
identifying at least one of the first pattern, the second pattern, the third pattern, or the fourth pattern, the identifying being performed by a hardware module and by processing at least one of the reference media data or the monitored media data;
determining a first time interval between two patterns selected from a group consisting of the first pattern, the second pattern, the third pattern, and the fourth pattern;
determining a second time interval between two patterns selected from the group;
determining a difference between the first and second time intervals; and
storing the difference in the memory.

12. The method of claim 11 further comprising:
via a user interface, presenting the difference as a media synchronization error.

13. The method of claim 11, wherein the first time interval is a reference time interval between the first pattern and the second pattern, and wherein the second time interval is a monitored time interval between the third pattern and the fourth pattern.

14. The method of claim 11, wherein the first time interval is between the first pattern and the third pattern, and wherein the second time interval is between the second pattern and the fourth pattern.

15. The method of claim 11, wherein the identifying of at least one of the first pattern, the second pattern, the third pattern, or the fourth pattern is based on information representative of at least one of a luminance of light or an amplitude of a sound wave.

16. The method of claim 11, wherein at least one of the first media content or the second media content includes at least one of video data or audio data.

17. The method of claim 11, wherein the identifying of at least one of the first pattern, the second pattern, the third pattern, or the fourth pattern includes:
selecting a reference portion of the reference media data;
selecting a candidate portion of the monitored media data;
determining a correlation value based on the reference portion and on the candidate portion; and
determining that the correlation value transgresses a correlation threshold to identify at least one of the first pattern, the second pattern, the third pattern, or the fourth pattern.

18. The method of claim 11, wherein the identifying of at least one of the first pattern, the second pattern, the third pattern, or the fourth pattern includes:
selecting first and second portions of the reference media data or of the monitored media data;
based on the first portion, determining a first value of the first portion;
based on a second portion, determining a second value of the second portion;
determining a temporal change based on the first and second values; and
determining that the temporal change transgresses a temporal threshold to identify the first pattern, the second pattern, the third pattern, or the fourth pattern.

19. A device comprising:
a memory;
an access module to:
access reference media data stored in the memory, the reference media data including a first pattern of first media content and including a second pattern of second media content; and
access monitored media data stored in the memory, the monitored media data including a third pattern of first media content and including a fourth pattern of second media content, the third pattern corresponding to the first pattern, the fourth pattern corresponding to the second pattern;
a hardware-implemented identification module to identify at least one of the first pattern, the second pattern, the third pattern, or the fourth pattern by processing at least one of the reference media data or the monitored media data; and
a processing module to:
determine a first time interval between two patterns selected from a group consisting of the first pattern, the second pattern, the third pattern, and the fourth pattern;
determine a second time interval between two patterns selected from the group;
determine a difference between the first and second time intervals; and
store the difference in the memory.

20. The device of claim 19 further comprising a user interface module to present the difference as a media synchronization error.

21. The device of claim 19, wherein at least one of the first media content or the second media content includes at least one of video data or audio data.

22. The device of claim 19, wherein the identification module is to:
select a reference portion of the reference media data;
select a candidate portion of the monitored media data;
determine a correlation value based on the reference portion and on the candidate portion; and
determine that the correlation value transgresses a correlation threshold to identify at least one of the first pattern, the second pattern, the third pattern, or the fourth pattern.

23. The device of claim 19, wherein the identification module is to:
select first and second portions of the reference media data or of the monitored media data;
based on the first portion, determine a first value of the first portion;
based on the second portion, determine a second value of the second portion;
determine a temporal change based on the first and second values; and
determine that the temporal change transgresses a temporal threshold to identify at least one of the first pattern, the second pattern, the third pattern, or the fourth pattern.

24. A machine-readable storage medium comprising a set of instructions that, when executed by one or more processors of a machine, cause the machine to:
access a reference stream of media data, the reference stream including a first video event and a first audio event;
access a monitored stream of media data, the monitored stream including a second video event and a second audio event, the second video event corresponding to the first video event, the second audio event corresponding to the first audio event;
identify at least one of the first video event, the second video event, the first audio event, or the second audio event, the identifying being performed by a hardware module of the machine and by processing at least one of the reference stream or the monitored stream;
determine a first time interval between two events selected from a group consisting of the first video event, the second video event, the first audio event, and the second audio event;
determine a second time interval between two events selected from the group;
determine a difference between the first and second time intervals; and
store the difference in a memory.

25. A system comprising:
means for accessing reference media data stored in a memory, the reference media data including a first pattern of first media content and including a second pattern of second media content;
means for accessing monitored media data stored in the memory, the monitored media data including a third pattern of first media content and including a fourth pattern of second media content, the third pattern corresponding to the first pattern, the fourth pattern corresponding to the second pattern;
means for identifying at least one of the first pattern, the second pattern, the third pattern, or the fourth pattern, the identifying being performed by processing at least one of the reference media data or the monitored media data;
means for determining a first time interval between two patterns selected from a group consisting of the first pattern, the second pattern, the third pattern, and the fourth pattern;
means for determining a second time interval between two patterns selected from the group;
means for determining a difference between the first and second time intervals; and
means for storing the difference in the memory.
